(19) United States
(12) Patent Application Publication
(10) Pub. No.: US 2015/0266356 A1
(43) Pub. Date: Sep. 24, 2015

(54) METHOD AND SYSTEM TO ENABLE COMMANDS ON A VEHICLE COMPUTER BASED ON USER CREATED RULES

(71) Applicant: FORD GLOBAL TECHNOLOGIES, LLC, Dearborn, MI (US)

(72) Inventors: Joel J. FISCHER, Royal Oak, MI (US); Joey Ray GROVER, Madison Heights, MI (US); Philip Joseph DANNE, Royal Oak, MI (US); Scott SMEREKA, Warren, MI (US)

(73) Assignee: FORD GLOBAL TECHNOLOGIES, LLC, Dearborn, MI (US)

(21) Appl. No.: 14/219,322

(22) Filed: Mar. 19, 2014

(51) Int. Cl. B60H 1/00; E05F 15/77; G05B 15/02; G01S 19/14

(52) U.S. Cl. CPC B60H 1/00735; G01S 19/14; E05F 15/77; G05B 15/02

(57) ABSTRACT

A vehicle computing system has at least one controller in communication with one or more transceivers, where the one or more transceivers are capable of communicating with a wireless device. The at least one controller is configured to recognize a vehicle occupant based on a wireless device connection received at the transceiver. The at least one controller is further configured to receive one or more infotainment rules based on the recognized vehicle occupant. The one or more infotainment rules are associated with at least one of time of day, calendar date, vehicle location, and exterior temperature. The at least one controller is further configured to control an infotainment system by adjusting control settings based on the one or more infotainment rules.

### TECHNICAL FIELD

The present disclosure generally relates to a user control technique, and more particularly to a set of user created rules for infotainment control subject to user preferences.

### BACKGROUND

U.S. Pat. No. 8,467,961 generally discloses a navigation device having user profiles that may be stored and used to navigate a user who may be driving in a vehicle, on foot, or in another mode of transportation. Each user profile corresponds to one of the user's personae. In one embodiment the user business profile corresponds to the user's business persona, which is different from the user personal profile corresponding to the user's personal persona. The navigation device provides the user with a navigated route, together with information concerning the favorite facilities and events surrounding the navigated route, which satisfy the preferences in a selected user profile. In some embodiments, blockages may be established using the device to avoid selected areas, e.g., high crime areas, in the navigated route, or to block transmission of selected information concerning, e.g., uninteresting facilities and events, to the navigation device.

U.S. Pat. No. 8,527,013 generally discloses systems, methods, and devices for controlling and limiting use of functions, such as calling, texting, chatting, emailing, Internet surfing, and similar applications, on a mobile device when the mobile device is in a moving vehicle, includes use of an on-board computer installed within the vehicle, a transmitter in electronic communication with the on-board computer that periodically transmits speed data of the vehicle to a receiver installed on the mobile device, wherein the mobile device includes suitable software and a rules-based policy that define and control when and which functions of the mobile device are disabled or interrupted by the software when the vehicle is in motion above a minimum threshold speed. Policies are set by default but may be customized for particular individuals, devices, or circumstances. Policies may also be customized for particular groups or subgroups of employees or contractors for company or legal compliance to reduce distracted driving.

U.S. Patent Application 2013/0145065 generally discloses methods and systems for a controlling device features based on vehicle state and device location. Specifically, the device may be any type of electrical device capable of transmitting and/or receiving a signal (such as a phone, tablet, computer, music player, and/or other entertainment device). In some instances, the device may be associated with one or more vehicles. Although the device may be configured to run one or more applications, the functionality of the one or more applications may be controlled by a system associated with the vehicle. In some cases, this control may depend on the device application type, device location (either inside or outside of a vehicle), law, operator state, and/or vehicle state.

### SUMMARY

In at least one embodiment, a garage door management method to enable a garage door to open and close automatically based on one or more management rules defined by a user. The method may receive input at a computer defining a threshold distance between a garage door and a vehicle. The method may receive input at the computer defining a garage door event corresponding to the threshold distance. The method may determine a distance to the garage door and if the distance is equal to the threshold distance, transmit an event signal.

In at least one embodiment, a climate management system has at least one controller in communication with a transceiver, the transceiver being capable of communication with one or more wireless devices. The at least one controller configured to recognize a user based on a wireless device in communication with the transceiver. The at least one controller is further configured to retrieve climate management rules based on the recognized user. The climate management rules having one or more predefined settings correlated with at least one of temperature, precipitation, and travel time. The at least one controller is further configured to control a climate system based on the climate management rules.

In at least one embodiment, a vehicle computing system having at least one controller in communication with one or more transceivers, the one or more transceivers capable of communication with one or more wireless devices. The at least one controller configured to recognize a vehicle occupant based on a handheld device connection received at the transceiver and receive one or more infotainment rules based on the recognized vehicle occupant. The one or more infotainment rules are associated with at least one of time of day, calendar date, vehicle location, and exterior temperature. The at least one controller is further configured to control an infotainment system by adjusting control settings based on the one or more infotainment rules.

### BRIEF DESCRIPTION OF THE DRAWINGS

FIG. 1 is an exemplary block topology of a vehicle infotainment system implementing a user-interactive vehicle information display system according to an embodiment;

FIG. 2 is an exemplary block topology of a system for integrating one or more connected devices with a vehicle based computing system according to an embodiment;

FIG. 3 illustrates a profile setting page for climate control management rules stored in a vehicle based computing system according to an embodiment;

FIGS. 4A-4B illustrate a profile setting page for garage door management rules stored in a vehicle based computing system according to an embodiment;

FIG. 5 is a flow chart illustrating an example method of a computing system providing management rules for one or more systems according to an embodiment;

FIG. 6 is a flow chart illustrating an example method of a computing system providing management rules for a climate control system according to an embodiment; and

FIG. 7 is a flow chart illustrating an example method of a computing system providing management rules for a garage door management system according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A vehicle computing system may have several system features that require a user to input one or more settings based on personal preference. One of the system features may include, but is not limited to, a climate control system. A user may have to set up their climate control system based on a change in interior and/or exterior temperatures by manually selecting options offered by the system. For example, a user may want the heated seat feature enabled for the first fifteen minutes of the car ride on days that have temperatures of twenty-five Fahrenheit (25 F) or less. The user would have to manually turn on the heated seat and/or manually shut off the heated seats after fifteen minutes.

Another system feature may include, but is not limited to, the one or more user interface displays. A user may request a specific user interface screen at the one or more interface displays to occur at a specific time of day. For example, in the morning commute to work, the user may request the traffic report for the route he/she takes to work, the user may request particular phone numbers that he usually calls in the morning (e.g., office, voicemail, assistant, etc. . . . ), and/or may want to listen to a particular news station in the morning. The user would have to manually select the options that he/she may want to see presented at a certain time of day and/or location.

The present disclosure provides a system and method that may implement a series of rule-based interactions preconfigured by a user. The rule-based interactions may be stored at local memory of the vehicle computing system, stored at the user's nomadic device, and/or downloaded from a repository of some sort by the user. The user may configure several systems in communication with the vehicle computing system such that it may automatically adjust settings based on time of day, calendar date, location, temperature, vehicle speed, calendar appointments, and/or a combination thereof. The vehicle computing system may be preconfigured and/or learn specific behaviors of user preferences adjusted on manually selected options offered by the computing system. For the rule-based interaction of one or more systems in a vehicle described herein, the pre-configuration of user settings can be realized as discussed below.

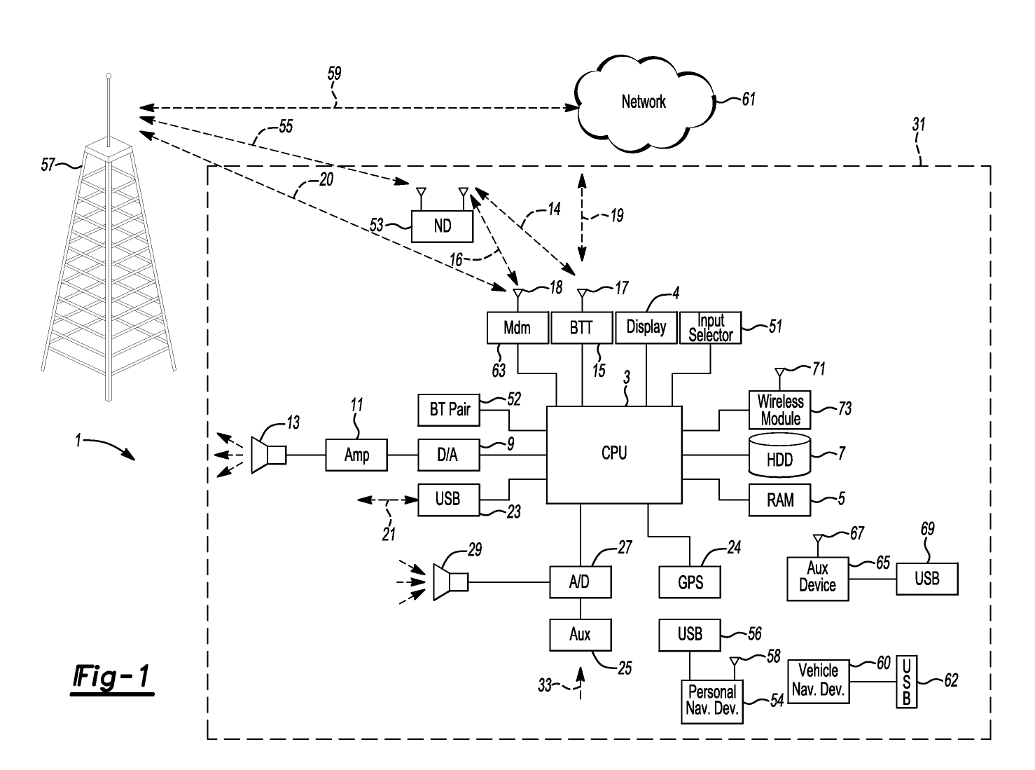

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

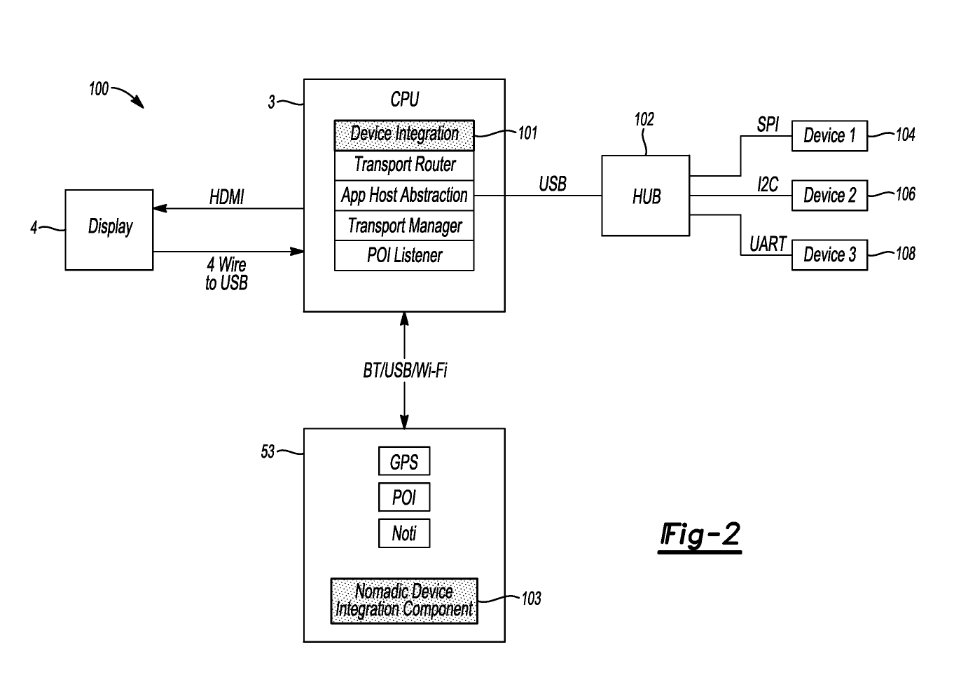

FIG. 2 is an exemplary block topology of a system 100 for integrating one or more connected devices with the vehicle based computing system 1 (VCS) according to one embodiment. The CPU 3 may be in communication with one or more transceivers. The one or more transceivers are capable for wired and wireless communication for the integration of one or more devices. To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101.

The one or more transceivers may include a multiport connector hub 102. The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (12C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

The VCS 1 may receive at least a portion of data from one or more connected devices and format the at least a portion of data for output to one or more user interfaces. The one or more user interfaces may include, but is not limited to, a display 4 (e.g., touchscreen), speakers and/or an instrument cluster and gages. In one example, the display may allow for user input using soft keys on the touchscreen, interaction with knobs and switches, and/or voice commands. The display configuration may include, but is not limited to, an HDMI (four-wire) connection between the CPU 3 and the touchscreen display 4.

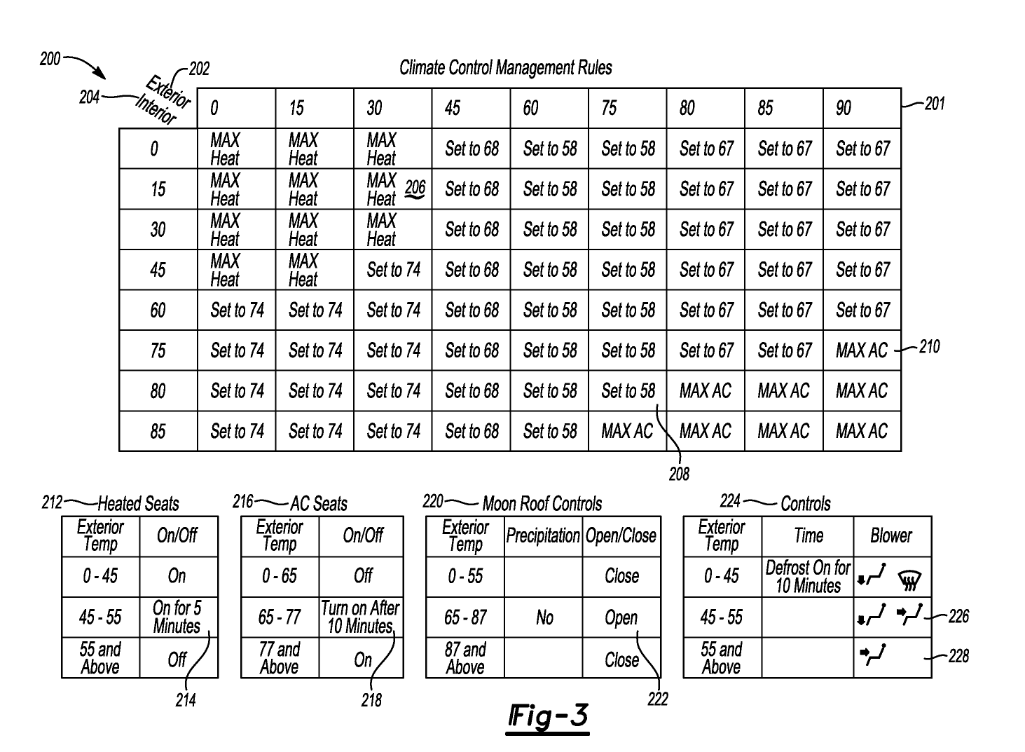

FIG. 3 illustrates a profile setting page for climate control management rules 200 stored in a vehicle based computing system according to an embodiment. The VCS 1 may have a user profile setting for one or more systems that are operated based on a user preference. The profile setting may include climate control management rules 200 for the user to set up a profile corresponding to one of his/her preference.

The climate control management rules 200 may include one or more tables that may be set up by a user. The user may set up the climate control management rules 200 in the vehicle using at least one of a liquid crystal display (LCD) touchscreen, one or more selector buttons and dials associated with the computing system, and/or a combination thereof. The user may set up the climate control management rules 200 using a nomadic device 53 having an application associated with the vehicle computing system. The user may set up the climate control management rules 200 while the nomadic device is online in communication with the VCS 1 or offline at a remote location.

For example, the user may set up the climate control management rules 200 using a website, which may then be transmitted to a nomadic device application and/or directly to the VCS 1. The user may configure their preferences and share these preferences with an online community at the website.

A user may configure the climate control management rules 200 using an application associated with the VCS 1 on a nomadic device 53. The application being executed with hardware on the nomadic device 53 to present the user with one or more tables including, but not limited to, a temperature management table 201 having multiple rule entries. The temperature management table 201 having an x-axis representing exterior temperature 202 and a y-axis representing interior temperature 204. The user may populate the temperature management table 201 with climate control setting that may change based on interior and/or exterior temperature. Once communication has been established between the nomadic device 53 and VCS 1, the nomadic device 53 may communicate the temperature management table 201 to the VCS 1 for execution.

For example, the user may configure the management of the climate control system by requesting max heat 206 from the system if the exterior temperature is thirty Fahrenheit (30 F) and the interior temperature is thirty Fahrenheit (30 F). The user may program the climate control system to lower the temperature output as the interior temperature increases such that the interior temperature may remain at a steady state temperature.

The system may populate the temperature management table 201 based on previous selections made by a user. For example, the system may set the climate control system to fifty-eight degrees 208 Fahrenheit (58 F) based on monitoring and learning the user selections when the exterior temperature is at seventy five degrees Fahrenheit (75 F) and an interior temperature is at eighty degrees Fahrenheit (80 F).

The user may update the temperature management table 201 using the software application being executed with the hardware on the nomadic device 53. Once the VCS 1 recognizes the user based on the nomadic, the VCS 1 may receive the updated temperature management table and execute it on the hardware of the VCS 1. In another example, the user may set the climate control system to enable max AC 210 if the exterior temperature is ninety degrees Fahrenheit (90 F) and the interior temperature is seventy-five degrees Fahrenheit (75 F).

The climate control management rules 200 may include additional tables to control other features of the climate control system. The climate management rules 200 may include, but is not limited to, heated seat control 212, air conditioned (AC) seat control 216, blower motor direction control 224, and/or moon roof control 222. For example, the user may select heated seats to enable 214 when the exterior temperature measures forty-five degrees Fahrenheit (45 F). If the exterior temperature measures forty-five degrees Fahrenheit (45 F), the management rules may also include advanced setting based on a user preference of only enabling the heated seat control 212 for the first five minutes of the trip and to then disable the feature. The blower motor direction control 224 may include a blower selection for distributing air in certain zones 226 based on the exterior temperature measuring forty-five degrees Fahrenheit (45 F).

In another example, if the system measures seventy-five degrees Fahrenheit (75 F) the climate control management rules 200 may set the climate control system to fifty-eight degrees 208 Fahrenheit (58 F) based on the temperature management table 201. The climate control system may also enable 218 the AC seats control 216, command an open position 222 of the moon roof control 220 (if no precipitation is measured), and enable the blower motor direction control 224 to the upper vents 228 based on a user's climate control management rules if an exterior temperature of seventy-five degrees Fahrenheit (75 F) is measured.

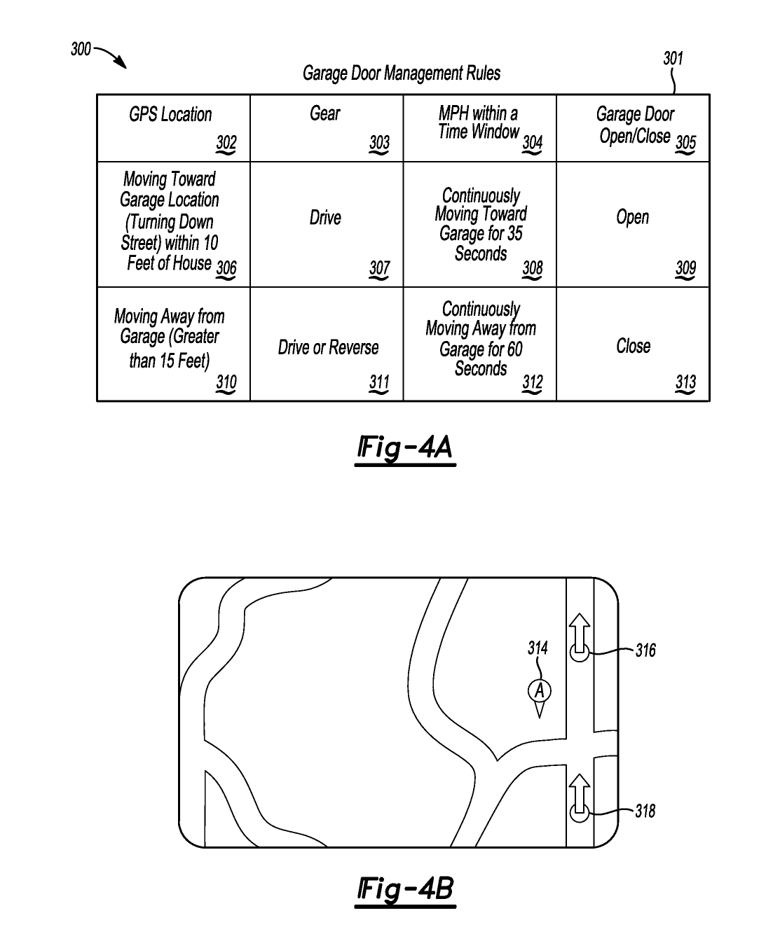

FIGS. 4A-4B illustrate a profile setting page for garage door management rules 300 stored in a vehicle based computing system according to an embodiment. In FIG. 4A, the garage door management rules 300 may include one or more tables 301 that are configured by a user using the in-vehicle interface controls of the VCS 1, at a website on the internet, and/or remotely using a nomadic device 53 having an application associated with the VCS 1. The garage door management rules table 301 may include one or more factors when determining whether to transmit an open or close command to the user's garage door.

The one or more factors may include, but is not limited to, GPS location 302, vehicle transmission gear 303, and/or a MPH within a predefined time window 304. Based on the one or more factors the VCS 1 may determine whether the vehicle is returning or leaving home to enable a garage door open/close command 305.

As shown in FIG. 4B, a GPS system may determine if the vehicle is moving toward 318 their garage 314 or moving away 316 from their garage 314. For example, the one or more factors in the garage door management rules table 301 may determine the GPS location 302 of the vehicle and determine whether the user is moving toward the direction (e.g., within ten feet) of the garage 306. The one or more factors may determine if the vehicle is in drive 307 and monitor the speed in miles per hour (MPH) within a predetermined time window 308 (e.g., MPH is greater than zero and is continuously moving for thirty-five seconds) to insure the vehicle is not stopping at a neighboring destination. Based on the predetermined time window 308 of the vehicle traveling toward the garage and the location of the vehicle is within a predefined distance to the garage, the VCS 1 may transmit a garage door open signal 309 to the garage door.

In another example, the one or more factors in the garage door management rules table 301 may determine the GPS location 302 of the vehicle and determine whether the user is moving away (e.g., exceeding fifteen feet) from the garage 310. The one or more factors may determine if the vehicle is in drive or reverse 311 while monitoring the speed in MPH within a predetermined time window 312 (e.g., MPH is greater than zero and is continuously moving for sixty seconds) to insure the vehicle is not idling in the driveway or street. In response to the predetermined time window 312, if the vehicle is traveling away from the garage and the location of the vehicle exceeds a predefined distance to the garage, the VCS 1 may transmit a garage door close signal 313 to the garage door.

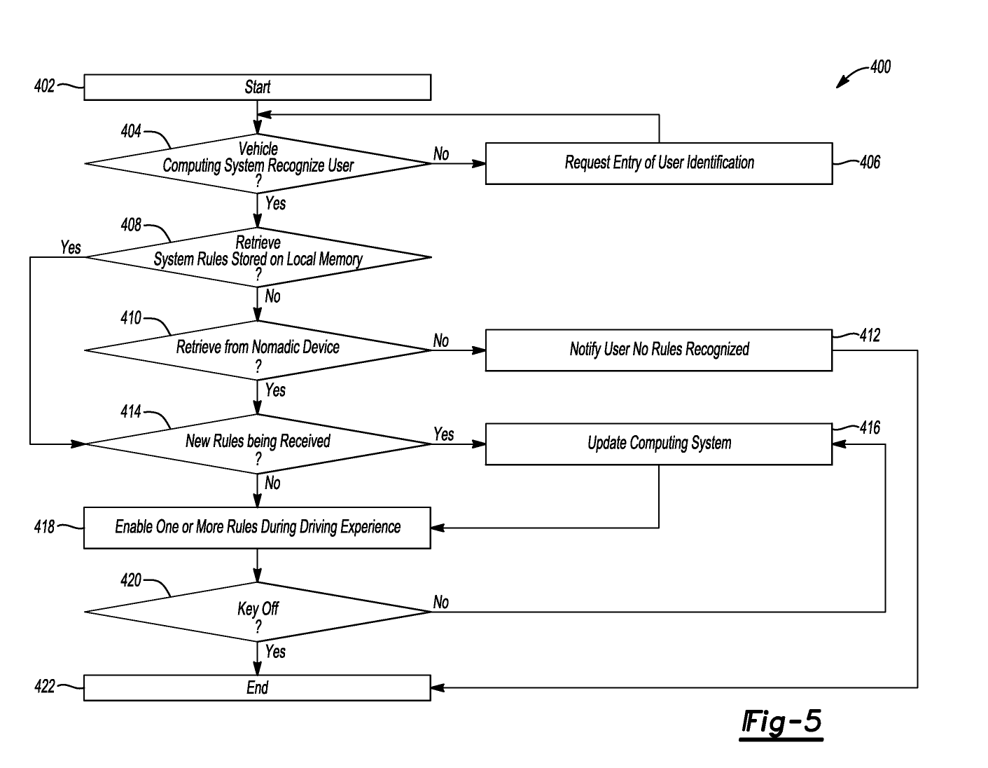

FIG. 5 is a flow chart illustrating an example method of a computing system providing management rules for one or more systems according to an embodiment. The method 400 may be implemented using software code contained within the VCS 1. In other embodiments, the method 300 may be implemented in other vehicle controllers, or distributed amongst multiple vehicle controllers.

Referring again to FIG. 5, the vehicle and its components illustrated in FIG. 1, FIG. 2, FIG. 3, and FIG. 4 are referenced throughout the discussion of the method to facilitate understanding of various aspects of the present disclosure. The method 400 of configuring several systems in communication with the vehicle computing system such that it may automatically adjust settings based on one or more factors in relation to a user's preference. The method of configuring several systems in communication with the VCS 1 may be implemented through a computer algorithm, machine executable code, or software instructions programmed into a suitable programmable logic device(s) of the vehicle, such as the vehicle control module, the device control module, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, during a key-on event which allows the vehicle to be powered on, the VCS 1 may begin powering up the one or more modules. The powering up of the one or more modules may cause system settings related to a recognized user to initialize before enabling one or more algorithms used to control the infotainment settings.

In operation 404, the VCS 1 may recognize a user based on one or more technologies including, but is not limited to, a smartphone connection, assigned key fob, biometrics, and/or a combination thereof. For example, the user may have a smartphone having an application related to the VCS 1 and communicating with the VCS 1 using wired and/or wireless technology. The user may “pair” his/her smartphone to automatically establish communication with the VCS 1 by using wireless technology (e.g., Bluetooth, Bluetooth Low Energy, Wi-Fi, etc. . . . ). Pairing the user's smartphone and/or other handheld device (e.g., nomadic device 53), allows the VCS 1 to wirelessly communicate with known devices associated recognized user.

In operation 406, if the VCS 1 does not recognize the user, the VCS may prompt a user to enter user identification information. The user identification information may include, but is not limited to, a user name, password, and/or a combination thereof. The user may enter the information by using an LCD touchscreen, soft buttons associated with the infotainment system, and/or a combination thereof.

In operation 408, the system may retrieve one or more system configuration rules that may be stored in local memory. If the one or more system configuration rules are not stored and/or not found on local memory, the VCS 1 may retrieve the configuration rules from a connected nomadic device in operation 410.

In operation 412, if no rules are retrieved in local memory and/or at the nomadic device 53, the VCS 1 may notify the user no rules are recognized. If the rules are retrieved, the VCS 1 may determine if there are new rules being received by the nomadic device 53 and/or the user is manually updating the configuration rules at the infotainment system interface in operation 414.

In operation 416, if new rules are recognized by the VCS 1, the system may update the respective one or more system configuration rules. The VCS 1 may enable one or more rules during the driving experience in operation 418.

In operation 420, the VCS 1 may continuously update the one or more system configuration rules based on several factors including, but not limited to, user input, updated rule configuration, and/or a combination thereof. For example, the user may have one or more configuration rules implemented for the climate control system. During the drive event the user may adjust a few settings that may be inconsistent with the one or more configuration rules. The VCS 1 may monitor the adjusted settings and updated the one or more configuration rules based on the adjustments made by the user. In another example, the VCS 1 may notify the user that the adjustments to the settings are inconsistent of the one or more configuration rules, and request acknowledgment from the user to accept these adjustments as the new rules.

In operation 422, the VCS 1 may have a vehicle key-off mode to allow the system to store one or more configuration rules in nonvolatile memory such that these predefined user settings may be used by the system for the next key-on event. In another embodiment, the VCS 1 may transmit the one or more configuration rules to a nomadic device 53 associated with the recognized user.

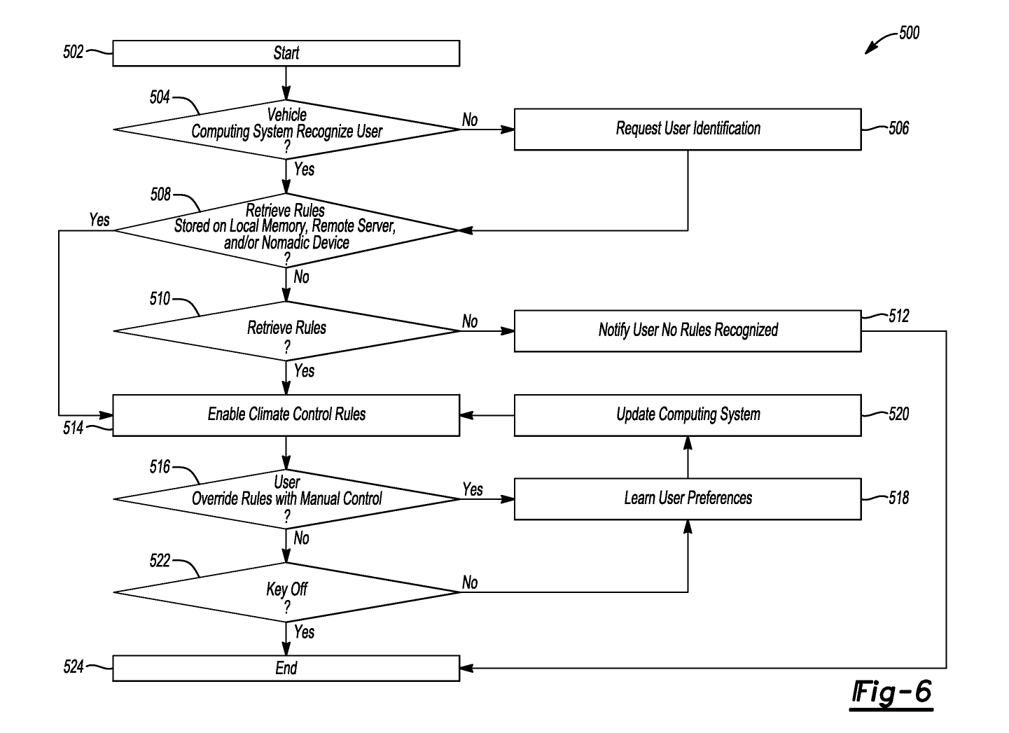

FIG. 6 is a flow chart illustrating an example method 500 of a computing system providing management rules for a climate control system according to an embodiment. The climate management rules and its components illustrated in FIG. 1, FIG. 2, and FIG. 3 are referenced throughout the discussion of the method 500 to facilitate understanding of various aspects of the present disclosure. The climate control system includes several inputs that adjust settings related to the performance of the system. The several inputs may include, but is not limited to, user inputs that are made based on personal preference. The user may adjust these inputs based on one or more factors including, but not limited to, exterior temperature, interior temperature, precipitation, length of trip, and/or a combination thereof.

In operation 502, during a VCS 1 power-on event, the climate control system may begin powering up the one or more control modules. The VCS 1 may recognize a user based on one or more technologies including, but is not limited to, a smartphone connection, assigned key fob, biometrics, and/or a combination thereof in operation 504.

In operation 506, if the VCS 1 does not recognize the user, the VCS 1 may prompt a user to enter user identification information. The user identification information may include, but is not limited to, a user name, password, and/or a combination thereof. The VCS 1 may retrieve one or more climate control configuration rules from at least one of the VCS 1 local memory, remote server in communication with the VCS 1, from a website, from a connected nomadic device 53, and/or a combination thereof in operation 508.

In operation 510, the VCS 1 may determine if there are rules to execute based on the recognized user. If no rules are retrieved in local memory and/or at the nomadic device 53, the VCS 1 may notify the user no rules are recognized in operation 512. If the rules are retrieved, the VCS 1 may enable the climate control configuration rules in operation 514.

In operation 516, the user may override the one or more climate control configuration rules by manually adjusting a selection/feature. The VCS 1 may recognize the manual selection of the climate control system and may update the configuration rules in operation 518.

For example, if the configuration management rules for the climate control system enables max AC at exterior temperature eighty-five degrees Fahrenheit (85 F) and interior temperature at seventy-four degrees Fahrenheit (74 F), the user may adjust the system to enable a new set temperature of seventy-seven degrees Fahrenheit (77 F) instead of max AC. Before powering down the VCS 1, the system may request the user to accept or deny saving the manually updated changes to the climate control configuration rules.

In operation 520, the VCS 1 may update the climate control configuration rules based on monitoring user input to improve the comfort during the driving experience. The climate control configuration rules may include additional factors, including, but not limited to, travel time and/or time of day. For example, the user may request the climate control configuration rule to change if the travel time exceeds 45 minutes (e.g., lower the temperature in the vehicle cabin at each rule entry because of increased time of travel). In another example, the user may request the climate control configuration rules to change each rule entry if the user is traveling at night compared to the afternoon (e.g., increase the temperature by five degrees at each rule interval during night time hours because no warmth from sunlight). In another example, the climate control configuration rule may have one or more tables based on several factors including, but not limited to, night driving, day driving, precipitation, and/or a combination thereof.

In operation 522, the VCS 1 may recognize a key-off request. The VCS 1 may have a vehicle key-off mode to allow the system to store climate management rules in nonvolatile memory such that these predefined user settings may be used by the system for the next key-on event in operation 524. In another embodiment, the VCS 1 may transmit the climate management rules to a nomadic device associated with the recognized user.

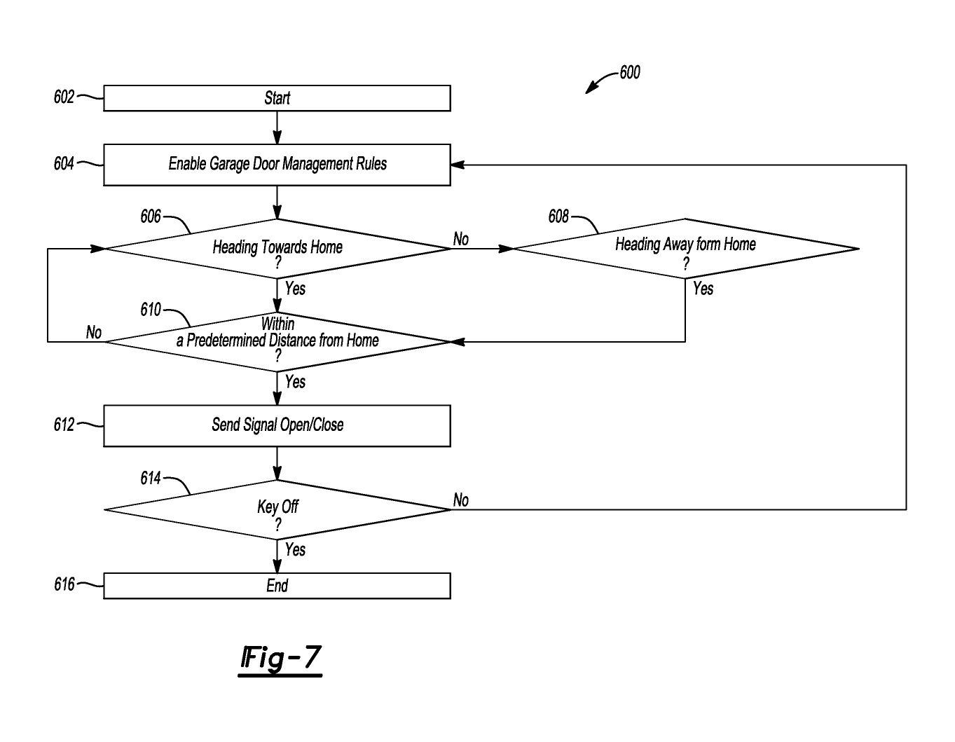

FIG. 7 is a flow chart illustrating an example method 600 of a computing system providing management rules for a garage door management system according to an embodiment. The garage management rules and its components illustrated in FIG. 1, FIG. 2, FIG. 4A, and FIG. 4B are referenced throughout the discussion of the method 600 to facilitate understanding of various aspects of the present disclosure. The garage door management rules may include one or more tables that are configured by a user. The one or more tables may include one or more factors to determine whether an open or close command is transmitted to the user's garage door. The one or more factors may include, but is not limited to, GPS location, vehicle transmission gear, a predefined distance, and/or a predefined time window in relation to MPH.

In operation 602, a VCS 1 power-on event may enable one or more control modules to initialize the rule-based advance vehicle commands. Once the initialization is complete, the VCS may enable the garage door management rules in operation 604. The user may setup the garage door management rules by entering in a few data points including, but not limited to, a home address, length of driveway (e.g., to determine a predefined distance to transmit signal), and a time window to transmit signal (e.g., user request delay).

In operation 606, the VCS 1 may continuously monitor the GPS location to determine if the vehicle is driving towards home. The VCS 1 may continuously monitor the GPS location to determine if the vehicle is driving away from home in operation 608.

For example, the GPS may determine based on the home address if the vehicle is headed toward the home address destination. If the vehicle is headed toward the home address destination, the VCS 1 may implement one or more predefined calibration points to determine when to transmit the open signal event to command the garage door to open.

In operation 610, if the VCS 1 establishes that the vehicle is driving away from home based on GPS location data, it may begin analysis of calculating the distance the vehicle is moving away from the garage. Based on the calculated distance, which is a user predefined variable, the VCS 1 may transmit a close signal to the garage in operation 612.

In another embodiment, the VCS 1 may determine if the user is moving the car to the street to park, and/or the car is idling in the driveway by using additional factors including, transmission gear, MPH, a signal transmission delay timer, and/or a combination thereof. These additional factors may improve the intelligence of the garage door management rules to prevent false transmission of an open or close signal.

In operation 614, the VCS 1 may recognize a key-off event. The VCS 1 may have a vehicle key-off mode to allow the system to store the garage management rules in nonvolatile memory such that these predefined user settings may be used by the system for the next key-on event in operation 616. In another embodiment, the VCS 1 may transmit the garage management rules to a nomadic device associated with the recognized user.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A garage door management method, the method comprising:
receiving input at a computer defining a threshold distance between a garage door and a vehicle;
receiving input at the computer defining a garage door event corresponding to the threshold distance;
determining a distance to the garage door; and
if the distance is equal to the threshold distance, transmit an event signal corresponding to the event.

2. The method of claim 1, wherein the event signal is at least one of an open or close command for the garage door.

3. The method of claim 1, further comprising:
receiving mile-per-hour data in relation to a predefined time value, and
delaying the event signal if the mile-per-hour data is equal to zero for the predefined time value.

4. The method of claim 1, further comprising receiving GPS data to define a garage location and determining the distance from the vehicle to the garage door.

5. The method of claim 4, further comprising calculating a vehicle direction based on miles-per-hour data and the GPS data; and determining whether the vehicle is driving away from the garage door or towards the garage door.

6. The method of claim 5, wherein the threshold distance may be configured to have multiple settings based on the vehicle direction.

7. A climate management system comprising:
at least one controller in communication with a transceiver, the transceiver being capable of communication with one or more wireless devices, the at least one controller configured to:
recognize a user based on a wireless device in communication with the transceiver;
retrieve climate management rules based on the recognized user, the climate management rules having one or more predefined settings correlated with at least one of temperature, precipitation, and travel time; and
control a climate system based on the climate management rules.

8. The climate management system of claim 7, wherein the at least one controller is further configured to:
adjust the climate system based on received input at a user interface;
update the climate management rules in response to the input received at the user interface, and
control the climate system based on the updated climate management rules.

9. The climate management system of claim 7, wherein the one or more predefined settings are preconfigured by at least one of a vehicle interface controls, at a website, and a nomadic device.

10. The climate management system of claim 7, wherein the one or more predefined settings are temperature settings based on at least one of time of day, calendar date, and external temperature.

11. The climate management system of claim 7, wherein the one or more predefined settings are temperature settings based on exterior temperature and interior temperature.

12. The climate management system of claim 7, wherein the one or more predefined settings are at least one of heated seat settings, air conditioned seat settings, and sun roof operation.

13. A vehicle computing system comprising:
at least one controller in communication with one or more transceivers, the one or more transceivers capable of communication with one or more wireless devices, the at least one controller configured to:
recognize a vehicle occupant based on a handheld device connection received at the transceiver;
receive one or more infotainment rules based on the recognized vehicle occupant; the one or more infotainment rules associated with at least one of time of day, calendar date, vehicle location, and exterior temperature; and
control an infotainment system by adjusting control settings based on the one or more infotainment rules.

14. The vehicle computing system of claim 13, wherein the at least one controller is further configured to establish communication with a remote server through the handheld device; and receive the one or more infotainment rules.

15. The vehicle computing system of claim 13, wherein the infotainment system is a climate control system.

16. The vehicle computing system of claim 15, wherein the one or more infotainment rules are at least one of temperature settings, heated seat control, AC seat control, and sun roof control.

17. The vehicle computing system of claim 13, wherein the one or more infotainment rules are predefined infotainment selections made by the vehicle occupant.

18. The vehicle computing system of claim 13, wherein the at least one controller is further configured to: receive additional input from the vehicle occupant to adjust control settings; request approval from the vehicle occupant if the adjusted control settings should be saved as a new infotainment rule; and in response to vehicle occupant approval, update the one or more infotainment rules based on the new infotainment rule.

19. The vehicle computing system of claim 13, wherein the one or more infotainment rules are configured at the handheld device using an application associated with the at least one controller.

20. The vehicle computing system of claim 13, wherein on the one or more infotainment rules are configured at a website associated with the at least one controller.
